(19) United States
(12) Patent Application Publication
(10) Pub. No.: US 2019/0319787 A1
(43) Pub. Date: Oct. 17, 2019

(54) HARDWARE ACCELERATION OF BIKE FOR POST-QUANTUM PUBLIC KEY CRYPTOGRAPHY

(71) Applicant: Intel Corporation, Santa Clara, CA (US)

(72) Inventors: ANDREW H. REINDERS, Portland, OR (US); Santosh Ghosh, Hillsboro, OR (US); Manoj Sastry, Portland, OR (US); Rafael Misoczki, Hillsboro, AZ (US)

(73) Assignee: Intel Corporation, Santa Clara, CA (US)

(21) Appl. No.: 16/456,096

(22) Filed: Jun. 28, 2019

(51) Int. Cl. H04L 9/08; G06F 7/53; G06F 7/72

(52) U.S. Cl. CPC H04L 9/0858; G06F 7/724; G06F 7/53

(57) ABSTRACT

In one example an apparatus comprises an unsatisfied parity check (UPC) memory, an unsatisfied parity check (UPC) compute block communicatively coupled to the UPC memory, a first error memory communicatively coupled to the UPC compute block, a polynomial multiplication syndrome memory, a polynomial multiplication compute block communicatively coupled to the polynomial multiplication syndrome memory, a second error memory communicatively coupled to the polynomial multiplication compute block, a codeword memory communicatively coupled to the UPC compute block and the polynomial multiplication compute block, a multiplexer communicatively coupled to first error memory and to the polynomial multiplication compute block, and a controller communicatively coupled to the UPC memory, the polynomial multiplication syndrome memory, the codeword memory, and the multiplexer. Other examples may be described.

### BACKGROUND

Subject matter described herein relates generally to the field of computer security and more particularly to hardware acceleration of bit flipping key encapsulation (BIKE) for post-quantum public key cryptography.

Existing public-key digital signature algorithms such as Rivest-Shamir-Adleman (RSA) and Elliptic Curve Digital Signature Algorithm (ECDSA) are anticipated not to be secure against attacks based on algorithms such as Shor's algorithm using quantum computers. As a result, there are efforts underway in the cryptography research community and in various standards bodies to define new standards for algorithms that are secure against quantum computers.

Accordingly, techniques to implement hardware acceleration of BIKE for post-quantum public key cryptography may find utility, e.g., in computer-based communication systems and methods.

### BRIEF DESCRIPTION OF THE DRAWINGS

The detailed description is described with reference to the accompanying figures.

FIG. 1 is a schematic illustration of compute blocks in a hardware engine to implement acceleration of BIKE for post-quantum public key cryptography, in accordance with some examples.

FIG. 2 is a flowchart illustrating operations in a method to implement hardware acceleration of BIKE for post-quantum public key cryptography, in accordance with some examples.

FIG. 3 is a flowchart illustrating operations in a method to implement hardware acceleration of BIKE for post-quantum public key cryptography, in accordance with some examples.

FIG. 4 is a schematic illustration of compute blocks in an architecture to implement a hardware accelerator, in accordance with some examples.

FIG. 5 is a schematic illustration of compute blocks in an architecture to implement a hardware accelerator, in accordance with some examples.

FIG. 6 is a schematic illustration of a computing architecture which may be adapted to implement hardware acceleration in accordance with some examples.

### DETAILED DESCRIPTION

Described herein are exemplary systems and methods to implement accelerators for post-quantum cryptography, and more particularly to hardware acceleration of BIKE algorithms for post-quantum public key cryptography. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the examples.

As described briefly above, existing public-key digital signature algorithms such as Rivest-Shamir-Adleman (RSA) and Elliptic Curve Digital Signature Algorithm (ECDSA) are anticipated not to be secure against attacks based on algorithms such as Shor's algorithm using quantum computers. As a result, there are efforts underway in the cryptography research community and in various standards bodies to define new standards for algorithms that are secure against quantum computers.

Bit Flipping Key Encapsulation (BIKE) is a key-exchange proposal to for post-quantum cryptography. BIKE is based on the difficulty of decoding QC-MDPC (Quasi-Cyclic Moderate Density Parity-Check) codes. The most expensive step in the BIKE algorithm is the QC-MDPC decoding procedure. The reference implementation for BIKE uses a bit-flipping decoder, which picks error bits to flip based on a number of parity check equations associated with the bits are unsatisfied. Many variations on these decoders have been tested, some of which count the number of unsatisfied parity checks (UPC) for one bit and then update that bit, some which count all UPC and update all bits, and some which try to correct incorrectly changed bits more aggressively than they change forward. Some of these approaches are more vulnerable to side channel attacks than others, particularly the approaches that count a single bit at a time.

Some BIKE implementations may use one or more of these techniques, some of which are better suited to hardware acceleration than others. Subject matter described herein is designed to improve the latency of the QC-MDPP decoding procedure by designing the decoder to perform many UPC counts in parallel at every stage of decoding. It also protects the private key and derived shared secret from information leakage by operating in constant time and always computes the UPC counts of every bit in every round. In some examples, the hardware engine is designed to perform many UPC counts in parallel using a wide internal datapath. This approach differs substantially from other hardware implementations, which do not take advantage of this available parallelism.

In some aspects, a BIKE hardware engine comprises a UPC engine, which is a BIKE-targeted hardware block to perform multiple UPC counts in parallel. The BIKE hardware engine reads through the syndrome and the private key and computes UPC counts for a number of positions equal to the internal word size, then chooses error bits to set or unset. Further, a self-contained BIKE decode hardware engine performs a complete QC-MDPC decode operation to produce an error vector from the ciphertext and the private key as one instruction. The same multiplier used in the decoder may be leveraged to accelerate the key generation and encode multiplication steps. Large internal word sizes make this operation more efficient for the BIKE hardware than for accelerated code on 32-bit microprocessors.

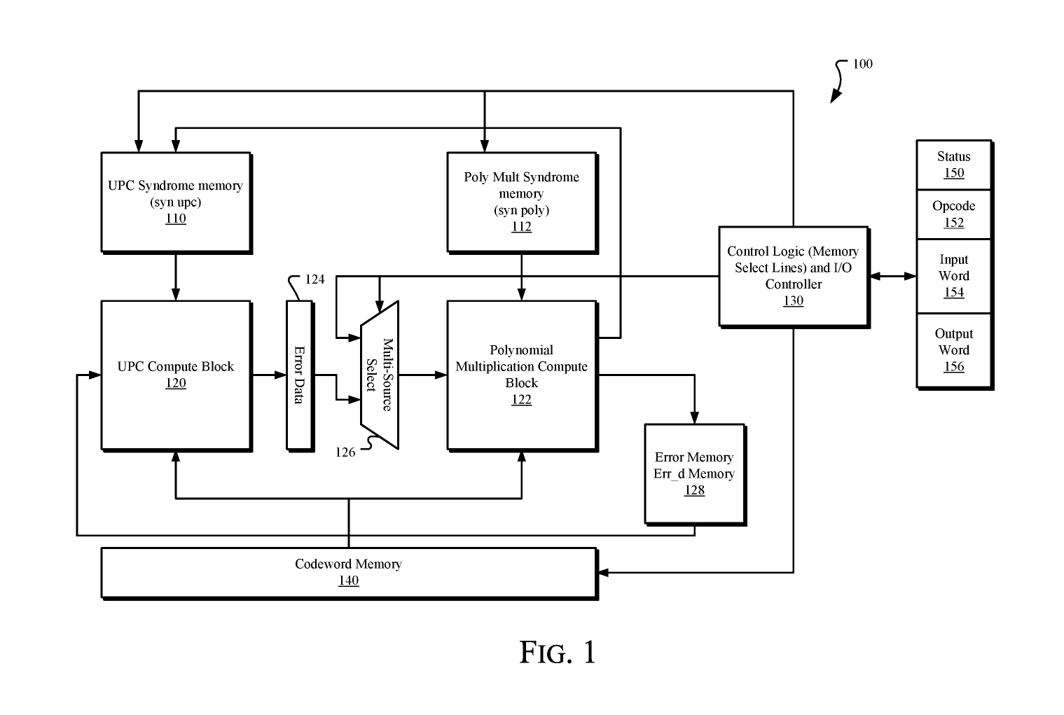

FIG. 1 is a schematic illustration of compute blocks in a hardware engine 100 to implement hardware acceleration of BIKE for post-quantum public key cryptography, in accordance with some examples. Referring to FIG. 1, hardware architecture 100 comprises a UPC syndrome memory (SYN UPC) 110 communicatively coupled to a UPC compute block 120 and a polynomial multiplication memory (SYN POLY) 112 communicatively coupled to a polynomial multiplication compute block 122. Hardware architecture 100 further comprises a control logic and input/output (I/O) controller 130 communicative coupled to the UPC syndrome memory and the polynomial multiplication memory 112, a codeword memory 140, and to a multiplexer 126. Hardware architecture 100 further comprises an error memory 128 communicatively coupled to the UPC compute block 120 and the polynomial multiplication compute block 122.

By way of overview, in some examples the BIKE hardware engine 100 accepts commands that instruct it to accept input, deliver output, or perform one of two available instructions: (1) decoding, and (2) polynomial multiplication. During operation, the UPC compute block 120 receives input from the UPC syndrome memory 110 and the codeword (i.e., private key) memory 140, and computes 128 UPC counts, then compares them to a threshold and passes them to the polynomial multiplication engine 122. A polynomial multiplication compute block 122 takes this word of error bit flips, or a word from the error memory 128, inputs from the codeword (i.e., private key) memory 140, and a word from the polynomial multiplication syndrome memory 112, to update that word of the polynomial multiplication syndrome memory 112. The UPC compute block 120 produces one word of error bits to flip, and the polynomial multiplication compute block 122 consumes one word every 257 cycles. In some examples the UPC compute block 120 executes during the first 256 of 257 blocks and the polynomial multiplication compute block 122 executes on the second through 257th blocks, so one-half round is performed in 66049 cycles. Further, in some examples pk0 and err0 are used in the first of each pair of 66049-cycle blocks, and pk1 and err1 are used in the second. This forms one round of decoding. Polynomial multiplication performs just one half round.

More particularly, in some examples the UPC compute block 120 receives 128 bits from UPC syndrome memory 110 and 255 bits from codeword memory 140 per cycle, and, after one pass through the input from UPC syndrome memory 110, outputs 128 bits of error bit flips into error data 124. The polynomial multiplication compute block 122 receives 128 bits of error bit flips from UPC compute block 120 or error memory 124 and 255 bits from codeword memory 140, per cycle, computes 128 bits of the polynomial product of these words, and add this to the corresponding word from the UPC syndrome memory 110.

In some examples the UPC syndrome memory 110 may be used to store a syndrome for a current round of decoding, while the polynomial multiplication syndrome memory 112 may be used to store an intermediate computation of the polynomial multiplication compute block 122. At the end of a round of computation, values may be stored in the UPC syndrome memory 110. The codeword memory 140 may be used to store the two halves of the private key (pk0, pk1) used in key generation and decoding, or the first multiplicand during encoding. The error data memory 124 may be used to store the two halves (err0, err1) of the accumulated error vector. The error memory 128 may be used to store the two halves (err_d0, err_d1) of the most recently computed error bit flips, or the second multiplicand of the polynomial multiplication instruction.

In some examples the control logic 130 increments the cycle, sub-round, and round counters, computes the memory addresses associated with each cycle of each instruction, and controls an input/output (I/O) interface. Table 1 illustrates examples of instructions applicable to the BIKE hardware engine 100.

TABLE 1

| | | Latency |
|---|---|---|
| Instruction | Description | (Clock Cycles) |
| Decode | Run decode algorithm. | 1320980 |
| poly mult | Perform pk0*err0 + pk1*err1 as 32749-bit | 66049 |
| | GF2 polynomials. Store in syn_poly | |
| write pk0 | Write to consecutive 128-bit words of pk | 1 |
| | memory 0, and clear words of err1. | |
| write pk1 | Write to consecutive 128-bit words of pk | 1 |
| | memory 1. | |
| write err0 | Write to consecutive 128-bit words of error | 1 |
| | memory 0. | |
| write err1 | Write to consecutive 128-bit words of error | 1 |
| | memory 1. | |
| read err0 | Read consecutive 128-bit words of error | 1 |
| | memory 0. | |
| read err1 | Read consecutive 128-bit words of error | 1 |
| | memory 1. | |
| read syn | Read consecutive 128-bit words of poly mult | 1 |
| | syndrome memory. | |

In some examples the interface to the BIKE hardware engine 100 is provided via memory-mapped input and output regions. A user writes four words to the input, then writes a command to load those words into the various memory units. Each memory unit is loaded 256 times to fill the memory. Another command starts the engine 100, either executing polynomial multiplication or decoding. The polynomial multiplication operation performs GF2 (Galois Field 2) polynomial multiplication on polynomials of size 32749, multiplying pk0 with err0. The decode step similarly computes pk0*err0+pk1*err1, as GF2 polynomials to produce the syndrome, then clears err0 and err1 and proceeds with the decoding algorithm. The decoding algorithm determines the lowest weight value of err0 and err1 such that pk0*err0+pk1*err1=syndrome, which therefore matches the value of err0 and err1 sent by the other party to the key agreement protocol. Once this is done, a sequence of commands pushes the contents of err0 and err1, 128 bits at a time, to the output memory region, from which it can be read.

In some examples the decoder operates on 128 bits of this error vector output at a time. Initially, UPC compute block 120 operates on a chunk of 128 bits, determining which bits to flip to best match the value of the syndrome, then it passes that data to the polynomial multiplication compute block 122, which updates the UPC syndrome memory 110 to reflect the data. The UPC compute block 120 counts the amount by how flipping any one bit would decrease the syndrome and thereby decides whether that bit should be flipped. The polynomial multiplication compute block 122 then updates the syndrome to reflect these changes. At each point in time, the UPC compute block 120 is working on the error bits that the polynomial multiplication compute block 122 will use in the next round, thereby pipelining the computation. After the UPC compute block 120 processes all bits of err0, the polynomial multiplication compute block 122 finishes the last 128 bits of err0, and the computation proceeds to err1. Nine rounds of computation has been shown to be sufficient to provide a decoding failure rate of less than 10⁻⁷.

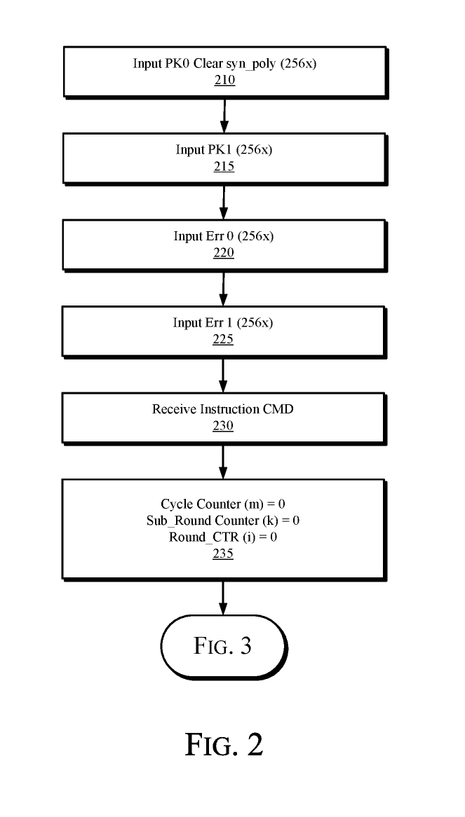

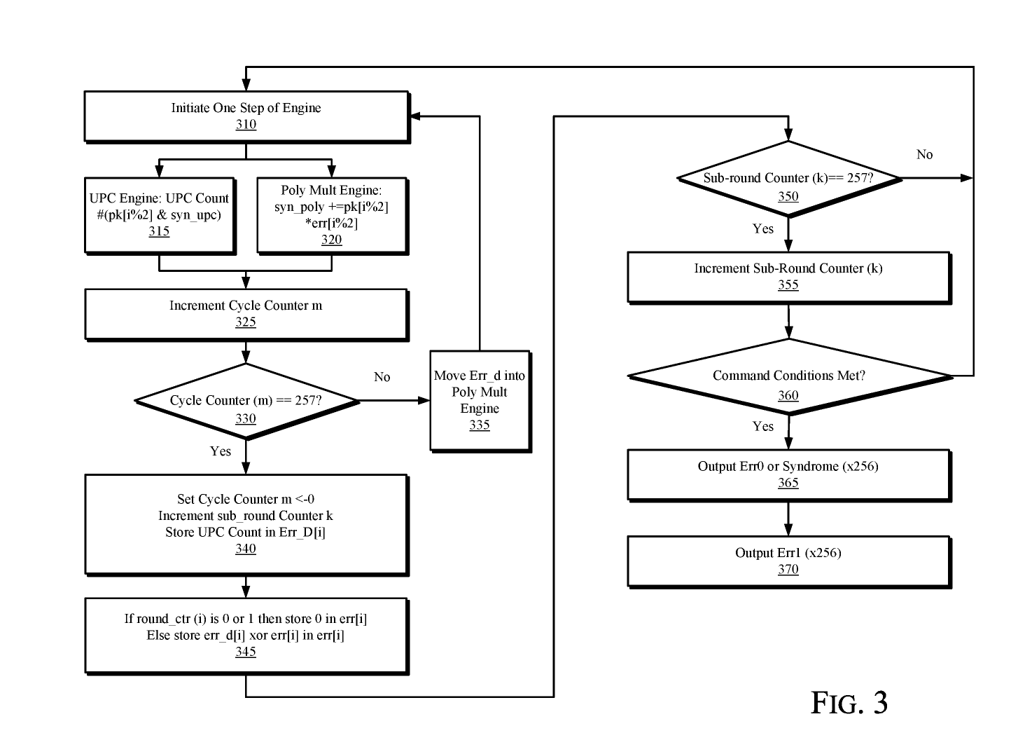

Having described various structural features, components, and operations of a BIKE hardware engine 100, operations of the BIKE hardware engine 100 will be described in greater detail with reference to FIGS. 2-3, which are flowcharts illustrating operations in a method to implement hardware acceleration of BIKE for post-quantum public key cryptography, in accordance with some examples.

Referring to FIG. 2, operations 210-230 are performed repeatedly to write inputs to memory. At operation 210 the first half of the private key (pk0) is input to the codeword memory 140 and the polynomial multiplication syndrome memory 112 is cleared. This operation may be repeated 256 times to load the codeword memory 140. At operation 215 the second half of the private key (pk1) is loaded to the codeword memory 140. This operation may be repeated 256 times to load the codeword memory 140. At operation 220 inputs are written to error memory 0 and at operation 225 inputs are written to error memory 1. As described above, each of these operations may be repeated 256 times to fill the various memory units.

At operation 230 an instruction command is received, and at operation 235 the cycle counter is set to zero, the sub-round counter is set to zero, and the half-round counter is set to zero. Control then passes to the operations depicted in FIG. 3.

Referring to FIG. 3, at operation 310 execution of one step of the BIKE hardware engine 100 is initiated. The operations utilize a round counter (i), a sub-round counter (k), and a cycle counter (m). For each round counter (i), sub-round counter (k), and cycle counter (m), the private key memory accesses memory line pk[i%2][511−k−m] and the double word of the private key (pk) supplied has memory addresses (pk[i%2][511−k−m], pk[i%2][511−k−m]). The other memory lines are set to read err[i%2][k] and write to err[i%2][k−1], read from syn_poly[255−m] and write to syn_poly[256−m], and read from and write to syn_poly[256−m].

At operation 315 the UPC compute block 120 performs a UPC count and at operation 320 the polynomial multiplication compute block 122 performs the calculation syn_poly+=pk[i][511−k−m]*err_d[i][k−1]. Operations 315 and 320 may be performed in parallel. At operation 325 the cycle counter (m) is incremented, and at operation 330 it is determined whether the cycle counter (m) equals 257. If, at operation 330, the cycle counter (m) has not reached 257 then control passes to operation 335 and the Err_d is moved into the polynomial multiplication compute block 122, and control then passes back to operation 310. Thus, operations 310-335 define a loop pursuant to which the UPC compute block 120 and the polynomial multiplication compute block 122 perform 257 cycles operations on the inputs to BIKE hardware engine 100.

By contrast, if at operation 330 the cycle counter has reached 257 then control passes to operation 340 and the cycle counter is set to 0, in sub-round counter (k) is incremented, and the bits to be flipped are stored in the err_d memory 128. At operation 345 a 0 is stored in the error memory if the round counter (i) is a 0 or 1, otherwise a value corresponding to err_d[k−1] ×or err[k−1].

If, at operation 350, the sub-round counter (k) has not reached 257 the control passes back to operation 310 and operations 310-345 are repeated. By contrast, if at operation 350 the sub-round counter (k) has reached 257 then control passes to operation 355 and the sub-round counter (k) is incremented.

At operation 360 it is determined whether a series of command conditions are met. In some examples the command conditions determine whether the command is a “poly mult” command as illustrated in Table 1 and the round counter i=1 or if the command is a “decode” command as illustrated in Table 1 and the round counter=20. If, at operation 360 a series of command conditions are not satisfied then control passes back to operation 310 and operations 310-355 are repeated. By contrast, if at operation 360 the series of command conditions are satisfied then control passes to operation 365 and 128-bit words of either Err0 or the syndrome are generated as outputs 256 times. At operation 370 words of Err1 are output 256 times.

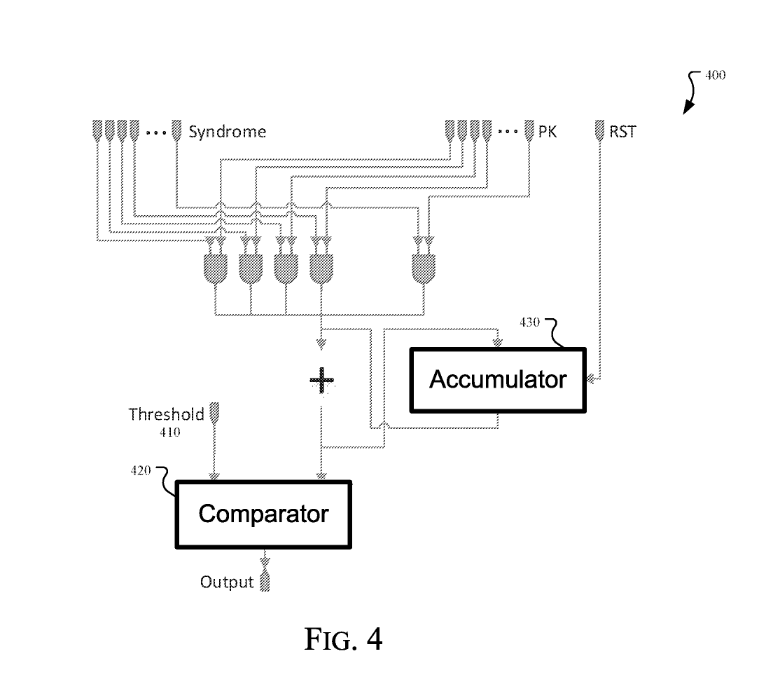

FIG. 4 is a schematic illustration of compute blocks in an architecture to implement a hardware accelerator, in accordance with some examples. More particularly, FIG. 4 illustrates one unit of the BIKE UPC circuit 400. The circuit 400 receives two 128-bit words and counts the parity of their bitwise AND, then compares it to a threshold 410 and outputs whether the accumulator 420 is greater than the bit. This computation accumulates 128 bits additively and adds this value to the value stored in the accumulator 430; it compares this value to the threshold 410 and outputs a 1 if it is at least the threshold value 410, and a 0 otherwise. On tick, the accumulator 430 stores 0 if reset is high, and the value of the sum otherwise. In some examples, 128 of these circuits 400 operate in parallel to accumulate 128 UPC count values; after passing through all 256 words of the private key (pk) and the syndrome, the UPC engine has accumulated 128 thresholds and computed the change to apply to 128 bits of the error vector.

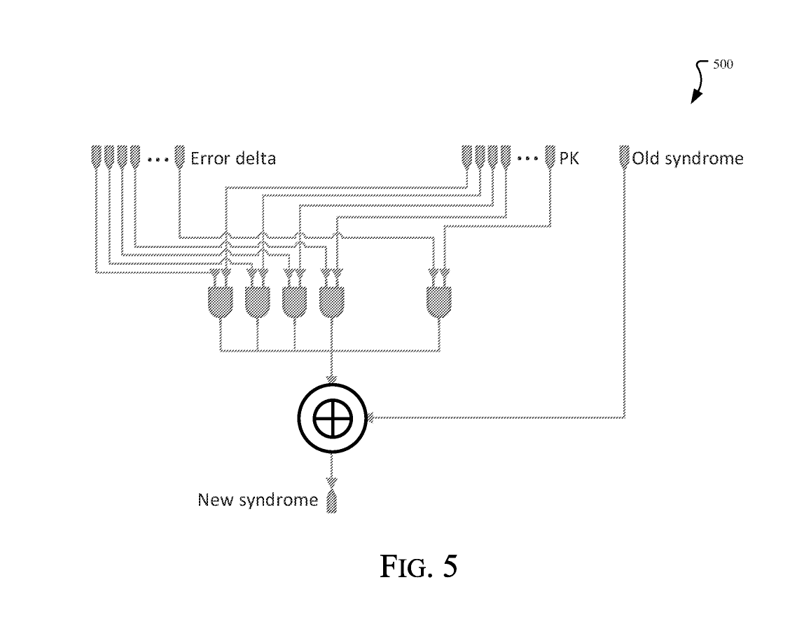

FIG. 5 is a schematic illustration of compute blocks in an architecture to implement a hardware accelerator, in accordance with some examples. More particularly, FIG. 5 illustrates a circuit 500 that computes the portion of the polynomial product between the word of error bit flips and the two selected words of the private key which modifies the selected word of the syndrome. These changes are XORed with the bits stored in that word of the syndrome, and then stored back in place on the next cycle.

The proposed invention presents a hardware-optimized alternative QC-MDPC decoder that is faster and more efficient than the BIKE submission reference implementation. Moreover, this invention enhances the BIKE design with side-channel protection against timing attacks.

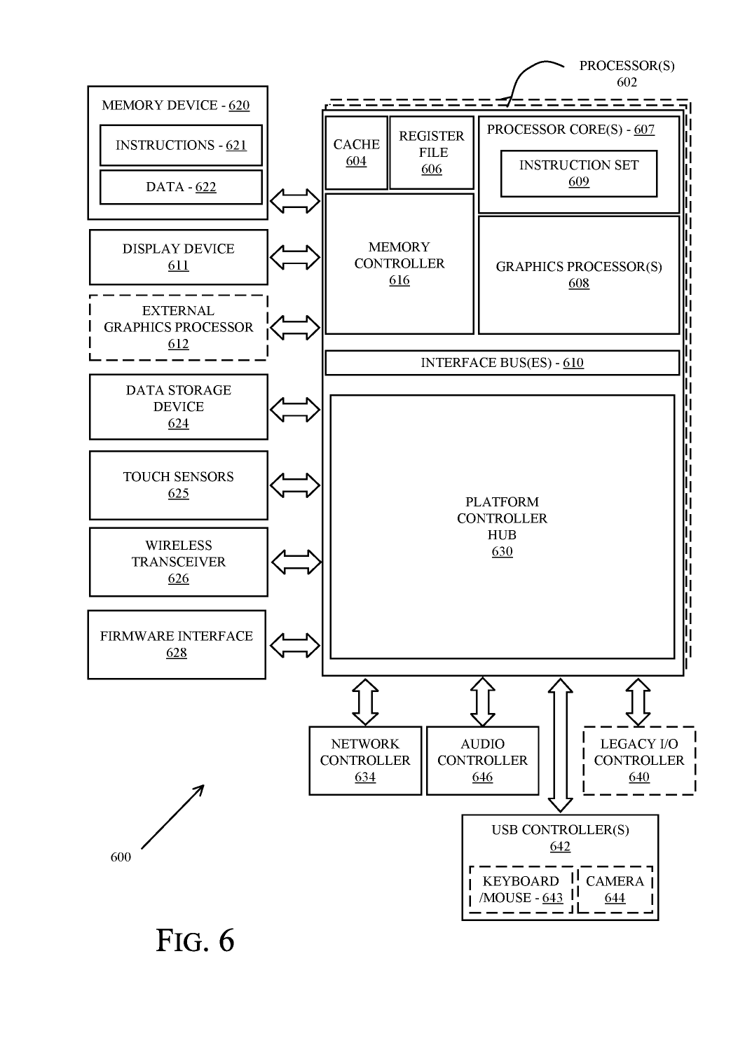

FIG. 6 illustrates an embodiment of an exemplary computing architecture that may be suitable for implementing various embodiments as previously described. In various embodiments, the computing architecture 600 may comprise or be implemented as part of an electronic device. In some embodiments, the computing architecture 600 may be representative, for example of a computer system that implements one or more components of the operating environments described above. In some embodiments, computing architecture 600 may be representative of one or more portions or components of a DNN training system that implement one or more techniques described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC or SOC) integrated circuit for use in mobile, handheld, or embedded devices.

An embodiment of system 600 can include, or be incorporated within a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 609. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 602 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, one or more processor(s) 602 are coupled with one or more interface bus(es) 610 to transmit communication signals such as address, data, or control signals between processor 602 and other components in the system. The interface bus 610, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 602 include an integrated memory controller 616 and a platform controller hub 630. The memory controller 616 facilitates communication between a memory device and other components of the system 600, while the platform controller hub (PCH) 630 provides connections to I/O devices via a local I/O bus.

Memory device 620 can be a dynamic random-access memory (DRAM) device, a static random-access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 executes an application or process. Memory controller hub 616 also couples with an optional external graphics processor 612, which may communicate with the one or more graphics processors 608 in processors 602 to perform graphics and media operations. In some embodiments a display device 611 can connect to the processor(s) 602. The display device 611 can be one or more of an internal display device, as in a mobile electronic device or a laptop device or an external display device attached via a display interface (e.g., DisplayPort, etc.). In one embodiment the display device 611 can be a head mounted display (HMD) such as a stereoscopic display device for use in virtual reality (VR) applications or augmented reality (AR) applications.

In some embodiments the platform controller hub 630 enables peripherals to connect to memory device 620 and processor 602 via a high-speed I/O bus. The I/O peripherals include, but are not limited to, an audio controller 646, a network controller 634, a firmware interface 628, a wireless transceiver 626, touch sensors 625, a data storage device 624 (e.g., hard disk drive, flash memory, etc.). The data storage device 624 can connect via a storage interface (e.g., SATA) or via a peripheral bus, such as a Peripheral Component Interconnect bus (e.g., PCI, PCI Express). The touch sensors 625 can include touch screen sensors, pressure sensors, or fingerprint sensors. The wireless transceiver 626 can be a Wi-Fi transceiver, a Bluetooth transceiver, or a mobile network transceiver such as a 3G, 4G, or Long Term Evolution (LTE) transceiver. The firmware interface 628 enables communication with system firmware, and can be, for example, a unified extensible firmware interface (UEFI). The network controller 634 can enable a network connection to a wired network. In some embodiments, a high-performance network controller (not shown) couples with the interface bus 610. The audio controller 646, in one embodiment, is a multi-channel high definition audio controller. In one embodiment the system 600 includes an optional legacy I/O controller 640 for coupling legacy (e.g., Personal System 2 (PS/2)) devices to the system. The platform controller hub 630 can also connect to one or more Universal Serial Bus (USB) controllers 642 connect input devices, such as keyboard and mouse 643 combinations, a camera 644, or other USB input devices.

The following pertains to further examples.

Example 1 is an apparatus, comprising an unsatisfied parity check (UPC) memory an unsatisfied parity check (UPC) compute block communicatively coupled to the UPC memory; a first error memory communicatively coupled to the UPC compute block; a polynomial multiplication syndrome memory; a polynomial multiplication compute block communicatively coupled to the polynomial multiplication syndrome memory; a second error memory communicatively coupled to the polynomial multiplication compute block; a codeword memory communicatively coupled to the UPC compute block and the polynomial multiplication compute block; a multiplexer communicatively coupled to first error memory and to the polynomial multiplication compute block; and a controller communicatively coupled to the UPC memory, the polynomial multiplication syndrome memory, the codeword memory, and the multiplexer.

In Example 2, the subject matter of Example 1 can optionally include the controller to initiate a process to load the codeword memory with a set of 256 codewords, each codeword comprising a first private key portion and a second private key portion.

In Example 3, the subject matter of any one of Examples 1-2 can optionally include the controller to initialize a set a cycle counter, a sub-round counter, and a round counter.

In Example 4, the subject matter of any one of Examples 1-3 can optionally include the controller to initiate a first series of calculations by the UPC compute block and the polynomial multiplication compute block.

In Example 5, the subject matter of any one of Examples 1-4 can optionally include the UPC compute block to receive a first input word from the codeword memory; receive a second input word from the UPC syndrome memory; and perform an unsatisfied parity check count using the first input word and the second input word.

In Example 6, the subject matter of any one of Examples 1-5 can optionally include the UPC compute block to generate one of a first output when the unsatisfied parity check count exceeds a threshold or a second output when the unsatisfied parity check fails to exceed the threshold.

In Example 7, the subject matter of any one of Examples 1-6 can optionally include an arrangement wherein the UPC compute block comprises a set of 128 UPC circuits that operation in parallel.

In Example 8, the subject matter of any one of Examples 1-7 can optionally include an arrangement wherein each UPC circuit in the set of 128 UPC circuits receives a first input word from the polynomial multiplication syndrome memory; receive a second input word from the UPC syndrome memory; and receive a third input from the multiplexer.

In Example 9, the subject matter of any one of Examples 1-8 can optionally include the polynomial multiplication compute block to perform a Galois Field 2 (GF2) polynomial multiplication operation.

In Example 10, the subject matter of any one of Examples 1-9 can optionally include the polynomial multiplication compute block to implement a decoding algorithm to determine a first error value and a second error value.

Example 11 is an electronic device, comprising a processor; and a bit flipping key encapsulation (BIKE) hardware accelerator, comprising an unsatisfied parity check (UPC) memory; an unsatisfied parity check (UPC) compute block communicatively coupled to the UPC memory; a first error memory communicatively coupled to the UPC compute block; a polynomial multiplication syndrome memory; a polynomial multiplication compute block communicatively coupled to the polynomial multiplication syndrome memory; a second error memory communicatively coupled to the polynomial multiplication compute block; a codeword memory communicatively coupled to the UPC compute block and the polynomial multiplication compute block; a multiplexer communicatively coupled to first error memory and to the polynomial multiplication compute block; and a controller communicatively coupled to the UPC memory, the polynomial multiplication syndrome memory, the codeword memory, and the multiplexer.

In Example 12, the subject matter of Example 1 can optionally include the controller to initiate a process to load the codeword memory with a set of 256 codewords, each codeword comprising a first private key portion and a second private key portion.

In Example 13, the subject matter of any one of Examples 1-2 can optionally include the controller to initialize a set a cycle counter, a sub-round counter, and a round counter.

In Example 14, the subject matter of any one of Examples 1-3 can optionally include the controller to initiate a first series of calculations by the UPC compute block and the polynomial multiplication compute block.

In Example 15, the subject matter of any one of Examples 1-4 can optionally include the UPC compute block to receive a first input word from the codeword memory; receive a second input word from the UPC syndrome memory; and perform an unsatisfied parity check count using the first input word and the second input word.

In Example 16, the subject matter of any one of Examples 1-5 can optionally include the UPC compute block to generate one of a first output when the unsatisfied parity check count exceeds a threshold or a second output when the unsatisfied parity check fails to exceed the threshold.

In Example 17, the subject matter of any one of Examples 1-6 can optionally include an arrangement wherein the UPC compute block comprises a set of 128 UPC circuits that operation in parallel.

In Example 18, the subject matter of any one of Examples 1-7 can optionally include an arrangement wherein each UPC circuit in the set of 128 UPC circuits receives a first input word from the polynomial multiplication syndrome memory; receive a second input word from the UPC syndrome memory; and receive a third input from the multiplexer.

In Example 19, the subject matter of any one of Examples 1-8 can optionally include the polynomial multiplication compute block to perform a Galois Field 2 (GF2) polynomial multiplication operation.

In Example 20, the subject matter of any one of Examples 1-9 can optionally include the polynomial multiplication compute block to implement a decoding algorithm to determine a first error value and a second error value.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
an unsatisfied parity check (UPC) memory;
an unsatisfied parity check (UPC) compute block communicatively coupled to the UPC memory;
a first error memory communicatively coupled to the UPC compute block;
a polynomial multiplication syndrome memory;
a polynomial multiplication compute block communicatively coupled to the polynomial multiplication syndrome memory;
a second error memory communicatively coupled to the polynomial multiplication compute block;
a codeword memory communicatively coupled to the UPC compute block and the polynomial multiplication compute block;
a multiplexer communicatively coupled to first error memory and to the polynomial multiplication compute block; and
a controller communicatively coupled to the UPC memory, the polynomial multiplication syndrome memory, the codeword memory, and the multiplexer.

2. The apparatus of claim 1, the controller to:
initiate a process to load the codeword memory with a set of 256 codewords, each codeword comprising a first private key portion and a second private key portion.

3. The apparatus of claim 2, the controller to:
initialize a set a cycle counter, a sub-round counter, and a round counter.

4. The apparatus of claim 3, the controller to:
initiate a first series of calculations by the UPC compute block and the polynomial multiplication compute block.

5. The apparatus of claim 1, the UPC compute block to:
receive a first input word from the codeword memory;
receive a second input word from the UPC syndrome memory;
perform an unsatisfied parity check count using the first input word and the second input word.

6. The apparatus of claim 5, the UPC compute block to:
generate one of a first output when the unsatisfied parity check count exceeds a threshold or a second output when the unsatisfied parity check fails to exceed the threshold.

7. The apparatus of claim 5, wherein the UPC compute block comprises a set of 128 UPC circuits that operation in parallel.

8. The apparatus of claim 7, wherein each UPC circuit in the set of 128 UPC circuits comprises:
receive a first input word from the polynomial multiplication syndrome memory;
receive a second input word from the UPC syndrome memory; and
receive a third input from the multiplexer.

9. The apparatus of claim 8, the polynomial multiplication compute block to:
perform a Galois Field 2 (GF2) polynomial multiplication operation.

10. The apparatus of claim 9, wherein polynomial multiplication compute block to:
perform a Galois Field 2 (GF2) polynomial multiplication operation.

11. An electronic device, comprising:
a processor; and
a bit flipping key encapsulation (BIKE) hardware accelerator, comprising:
an unsatisfied parity check (UPC) memory;
an unsatisfied parity check (UPC) compute block communicatively coupled to the UPC memory;
a first error memory communicatively coupled to the UPC compute block;
a polynomial multiplication syndrome memory;
a polynomial multiplication compute block communicatively coupled to the polynomial multiplication syndrome memory;
a second error memory communicatively coupled to the polynomial multiplication compute block;
a codeword memory communicatively coupled to the UPC compute block and the polynomial multiplication compute block;
a multiplexer communicatively coupled to first error memory and to the polynomial multiplication compute block; and
a controller communicatively coupled to the UPC memory, the polynomial multiplication syndrome memory, the codeword memory, and the multiplexer.

12. The electronic device of claim 11, the controller to:
initiate a process to load the codeword memory with a set of 256 codewords, each codeword comprising a first private key portion and a second private key portion.

13. The electronic device of claim 12, the controller to:
initialize a set a cycle counter, a sub-round counter, and a round counter.

14. The electronic device of claim 13, the controller to:
initiate a first series of calculations by the UPC compute block and the polynomial multiplication compute block.

15. The electronic device of claim 11, the UPC compute block to:
receive a first input word from the codeword memory;
receive a second input word from the UPC syndrome memory;
perform an unsatisfied parity check count using the first input word and the second input word.

16. The electronic device of claim 15, the UPC compute block to:
generate one of a first output when the unsatisfied parity check count exceeds a threshold or a second output when the unsatisfied parity check fails to exceed the threshold.

17. The electronic device of claim 15, wherein the UPC compute block comprises a set of 128 UPC circuits that operation in parallel.

18. The electronic device of claim 17, wherein each UPC circuit in the set of 128 UPC circuits comprises:
receive a first input word from the polynomial multiplication syndrome memory;
receive a second input word from the UPC syndrome memory; and
receive a third input from the multiplexer.

19. The electronic device of claim 18, the polynomial multiplication compute block to:
perform a Galois Field 2 (GF2) polynomial multiplication operation.

20. The electronic device of claim 19, wherein polynomial multiplication compute block to:
perform a Galois Field 2 (GF2) polynomial multiplication operation.
